(19) United States
(12) Patent Application Publication
(10) Pub. No.: US 2016/0017577 A1
(43) Pub. Date: Jan. 21, 2016

(54) DEVICE AND METHOD FOR PROTECTING WATER-BASED EQUIPMENT

(71) Applicant: Sang Min SEO, (US)

(72) Inventors: Sang Min Seo, Pohang-si (KR); Dueg Gon Ryu, Gyeongju-si (KR); Chang Hwan Jung, Pohang-si (KR)

(73) Assignee: Sang Min Seo, Pohang-si (KR)

(21) Appl. No.: 14/774,079

(22) PCT Filed: Sep. 4, 2013
(86) PCT No.: PCT/KR2013/007969

§ 371 Date: Sep. 9, 2015

(51) Int. Cl. E03B 7/10; A62C 35/68; E03B 7/07

(52) U.S. Cl. CPC E03B 7/10; E03B 7/075; A62C 35/68

(57) ABSTRACT

The present invention provides a device and a method for protecting water-based equipment which are capable of automatically preventing water-based equipment from breaking down or malfunctioning due to various reasons such as the freezing and bursting of a pipe, the start failure of a pump or an internal combustion engine, or the damage caused by a temperature increase inside the pump, even without performing periodic checks or having a manager with special knowledge or skills, or the like. Moreover, the present invention provides a device and a method for protecting water-based equipment being capable of protecting water-based equipment, in which the device is configured to be capable of preventing the pipe from freezing and bursting using the kinetic energy caused by the circulation of water in the pipe, and further configured to lead hot water made in a boiler into the suction side of the pump, so that a valve seat is opened, and water is circulated when the temperature of the pipe end becomes lower than a predetermined temperature, and when the temperature of the pipe is maintained over a predetermined temperature range, the valve seat is blocked, thereby performing thermal insulation of the pipe.

### TECHNICAL FIELD

The present invention relates to a method and apparatus for protection of a water-based system. More particularly, the present invention relates to a method and apparatus for protection of a water-based system using a solenoid valve operable at predetermined temperature and pressure.

### BACKGROUND ART

Generally, a water-based system is a system which uses water from a pump or a pipe, and examples of the water-based system include water supply facilities, fire extinguishing facilities, and industrial water supply facilities.

A water-based system automatically or manually operates a pressurized water supply including a pump and the like to discharge water through a valve at an end of a pipe.

Such a water-based system is exposed to a large amount of water and is thus likely to malfunction or break down for various reasons such as poor starting of a pump or an internal combustion engine and damage caused by increased temperature within a pump, which can endanger human lives and cause loss of property or tragic accidents in industrial settings.

In particular, when a high rise apartment building at Haeundae in Busan caught fire, malfunction of a sprinkler of water-based fire extinguishing facilities caused a tragic disaster including loss of life.

Water-based fire extinguishing facilities are very effective in putting out a fire in its early stage in an automatic or manual manner, and are particularly important in high-rise buildings or underground facilities, inaccessible by fire-fighting equipment such as a ladder truck, facilities for the elderly and children, in which a fire can cause large loss of life, and the like.

Such water-based fire extinguishing facilities require periodic inspection to check operation thereof. However, carelessness, negligence, lack of expertise, or unskillfulness of a manager makes it difficult to properly perform periodic inspection, thereby causing malfunction of the water-based fire extinguishing facilities in an emergency.

Examples of typical freeze protection methods include maintaining the interior of a pipe at a temperature above freezing by wrapping lagging around the pipe, winding a heating wire around a pump, or placing a heater in a pump chamber. However, such methods have a problem of large energy consumption and are insufficient to prevent the pipe from freezing and bursting when subfreezing weather lasts for a long time.

### DISCLOSURE

### Technical Problem

The present invention has been conceived to solve such problems in the related art, and it is one object of the present invention to provide a method and apparatus for protection of a water-based system, which can automatically prevent the water-based system from malfunctioning or breaking down for various reasons such as poor starting of a pump or an internal combustion engine and damage caused by increased temperature within the pump without conducting periodic inspection or having a manager with special knowledge or skills.

It is another object of the present invention to provide a method and apparatus for protection of a water-based system, which can prevent a pipe from freezing and bursting using kinetic energy created by circulation of water in the pipe, and can lead hot water produced by a boiler onto a suction side of a pump such that a valve is switched on to circulate water when the temperature at a pipe end is less than a predetermined value and a solenoid valve is switched off to thermally insulate the pipe when the temperature of the pipe is maintained at a predetermined value or more.

### Technical Solution

In accordance with one aspect of the present invention, a water-based system protection apparatus includes: a valve seat disposed in a pipe to open/close the pipe; a temperature sensor connected to one side of the pipe to measure temperature within the pipe; a resilient member connected to the valve seat at one end thereof to restore the valve seat to an original state thereof in the absence of electric signals; a pressure sensor connected to one side of the pipe to measure pressure within the pipe; a coil assembly generating electromagnetic force for switching on the valve seat when the temperature sensor or the pressure sensor senses a predetermined temperature or pressure; a contact being driven to allow electric power to be applied to the coil assembly through a first wire or a second wire when the temperature sensor or the pressure sensor senses a predetermined temperature or pressure; a plunger coupled to one end of the valve seat via the resilient member and being electromagnetically moved by translational motion within the coil assembly to switch the valve seat on/off when the contact is driven to allow electric power to be applied to the coil assembly through the first wire or the second wire.

The water-based system protection apparatus may further include a manual operation unit capable of manually driving the plunger to switch the valve seat on/off.

The first wire or the second wire may be connected to a control panel containing a timer to receive electric signals at predetermined intervals for a predetermined period of time.

The pressure sensor may be a bellows-type pressure sensor, the temperature sensor and the pressure sensor may be disposed vertically with respect to a longitudinal direction of the pipe, and the plunger may also be disposed vertically with respect to a longitudinal direction of the pipe.

In accordance with another aspect of the present invention, a water-based system protection method uses a water-based system protection apparatus comprising: a valve seat disposed in a pipe to open/close the pipe; a temperature sensor connected to one side of the pipe to measure temperature within the pipe; a resilient member connected to the valve seat at one end thereof to restore the valve seat to an original state thereof in the absence of electric signals; a pressure sensor connected to one side of the pipe to measure pressure within the pipe; a coil assembly generating electromagnetic force for switching on the valve seat when the temperature sensor or the pressure sensor senses a predetermined temperature or pressure; a contact driven to allow electric power to be applied to the coil assembly through a first wire or a second wire when the temperature sensor or the pressure sensor senses a predetermined temperature or pressure; a plunger coupled to one end of the valve seat via the resilient member and being electromagnetically moved by translational motion within the coil assembly to switch the valve seat on/off when the contact is driven to allow electric power to be applied to the coil assembly through the first wire or the second wire, the method comprising: measuring, by the temperature sensor, temperature within the pipe; and, when the measured temperature is less than or equal to a predetermined value, applying electric power to the coil assembly such that the valve seat is driven to open the pipe and running water is supplied to the pipe to increase the temperature within the pipe so as to prevent the pipe from freezing and bursting.

The water-based system protection method may further include cutting off power supply to the coil assembly such that the valve seat closes the pipe when the measured temperature is higher than or equal to a predetermined value.

The water-based system protection method may further include measuring, by the pressure sensor, pressure within the pipe; and applying electric power to the coil assembly such that the valve seat is driven to open the pipe and running water is discharged from the pipe to reduce shut-off pressure, upon detecting abnormal increase in pressure within the pipe or excessive pressure variation such as water-hammer.

The water-based system protection method may further include: providing the water-based system protection apparatus to a discharge side of a water tank, a hydraulic switch for activation monitoring hydraulic pressure within the pipe and automatically activating a pump upon detecting decrease in hydraulic pressure due to operation such as valve opening, a hot water boiler, a pump or a relief valve connected thereto, or to each end of the pipe remote from these components and connected to a sprinkler, a foam extinguishing system, and a water spray extinguishing system in a high rise building; and connecting each water-based system protection apparatus to a control panel including a timer such that electric power is applied at predetermined intervals for a predetermined period of time to perform periodic inspection.

The control panel may activate the hydraulic switch for activation to operate a secondary pump connected to the hydraulic switch for activation such that the secondary pump is connected to a discharge side of the boiler to circulate hot water from the boiler to an end of the pipe, upon receiving an electrical signal indicating that temperature of the end of the pipe is less than or equal to a predetermined value from the temperature sensor of the water-based system protection apparatus.

The boiler may heat water using electricity, fossil fuel, solar heat, or industrial waste heat to produce hot water.

### Advantageous Effects

The present invention provides a method and apparatus for protection of a water-based system, which can prevent malfunction of a water-based system, freezing and bursting of a pipe in winter, and damage to a pump under shut-off pressure due to abnormal operation, and maintain a water-based system in a normal condition without periodic inspection or a manager with special knowledge or skills while protecting a water-based system from external conditions.

In addition, the present invention provides a method and apparatus for protection of a water-based system, which can perform periodic inspection by electrically connecting a water-based system to a control panel including a timer, and which can prevent freezing and bursting of a pipe using a secondary pump connected to a hot water boiler connected to the control panel.

### DESCRIPTION OF DRAWINGS

FIG. 1 is a water-based system protection apparatus according to one embodiment of the present invention.

FIG. 2 is a flowchart illustrating a water-based system protection method according to one embodiment of the present invention, aimed at preventing freezing and bursting of a pipe when temperature within the pipe is less than or equal to a predetermined value.

FIG. 3 is a flowchart illustrating a water-based system protection method according to one embodiment of the present invention, aimed at preventing malfunction of a water-based system when shut-off pressure at a pump side is less than or equal to a predetermined value.

FIG. 4 is a diagram of a water-based system illustrating a water-based system protection method according to one embodiment of the present invention.

FIG. 5 is a diagram of a water-based system illustrating a water-based system protection method according to another embodiment of the present invention.

### BEST MODE

Hereinafter, a method and apparatus for protection of a water-based system according to one embodiment of the present invention will be described in detail with reference to the accompanying drawings.

<Water-Based System Protection Apparatus>

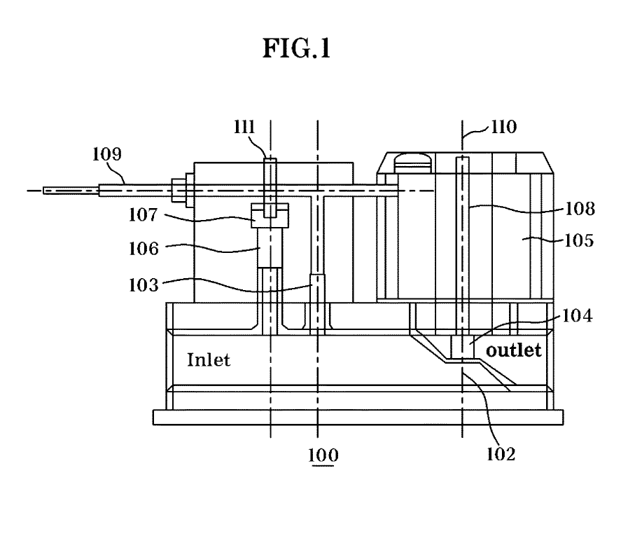

Referring to FIG. 1, a water-based system protection apparatus 100 according to one embodiment of the present invention includes: a housing 101 accommodating and supporting all components; a valve seat 102 placed in a pipe C to open/close the pipe C, which is disposed in the housing 101 and links an inlet Ito an outlet O; a temperature sensor 103 connected to one side of the pipe C to measure temperature within the pipe C; a resilient member or spring 105 connected at one end thereof to the valve seat 102 to restore the valve seat 102 to an original state thereof in the absence of electric signals; a pressure sensor 105 connected to one side of the pipe C to measure pressure within the pipe C; a coil assembly 106 generating electromagnetic force for switching the valve seat 102 on/off when the temperature sensor 103 or the pressure sensor 105 senses a predetermined temperature or pressure; a contact 110 driven to allow electric power to be applied to the coil assembly 106 through a first wire 108 or a second wire 109 when the temperature sensor 103 or the pressure sensor 105 senses a predetermined temperature or pressure; a plunger 110 coupled to one end of the valve seat 102 via the resilient member 104 and electromagnetically driven by translational motion within the coil assembly 106 to switch the valve seat 102 on/off when the contact 110 is driven to allow electric power to be applied to the coil assembly 106 through the first wire 108 or the second wire 109; and a manual operation unit 111 capable of manually driving the plunger 110 to switch the valve seat 102 on/off.

The water-based system protection apparatus 100 according to this embodiment of the invention may have a slim and simple overall structure in which the temperature sensor 103 and the pressure sensor 104 are placed vertically with respect to a longitudinal direction of the pipe C, and the plunger 110 switching the valve seat 102 on/off is placed vertically with respect to the longitudinal direction.

In addition, the pressure sensor 104 is a pressure bellows-type sensor and thus can electrically connect the contact 110 to the second wire 109 by internal negative pressure without a separate tool, when pressure within the pipe is higher than or equal to a predetermined value.

Further, the water-based system protection apparatus 100 according to this embodiment of the invention can automatically switch the valve seat 102 on/off using the temperature sensor 103 and the pressure sensor 105 measuring temperature and pressure within the pipe, respectively, and can manually switch the valve seat 102 on/off using the manual operation unit 111 even upon suffering failure in external power supply or other internal problems.

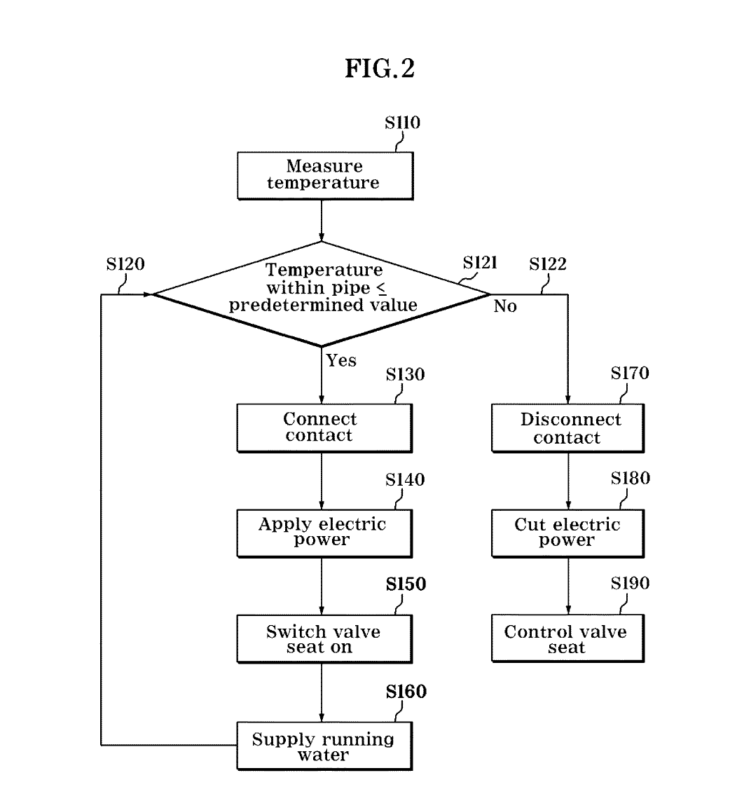

Next, a water-based system protection method using the water-based system protection apparatus 100 according to one embodiment of the present invention will be described with reference to FIG. 2 to FIG. 4.

First, a water-based system protection method using the water-based system protection apparatus 100 according to the embodiment of the invention will be described with reference to FIG. 2, illustrating the case that temperature within the pipe decreases to a predetermined value or less and the pipe is thus at risk of freezing and bursting.

Referring to FIG. 2, in the water-based system protection method using the water-based system protection apparatus 100 according to the embodiment of the invention, the temperature within the pipe is measured by the temperature sensor 103 (S110); the contact 110 disposed between the temperature sensor 103 and the first wire 108 connected to a power supply is connected to the first wire 108 (S130), when the temperature measured by the temperature sensor 103 is decreased to a predetermined value or less; and electric power is applied to the coil assembly 106 through the first wire 108 (S140).

When electric power is applied to the coil assembly 106, the plunger 107 is moved away from the valve seat 102 by translation motion due to a magnetic field generated in the coil assembly 106, and the resilient member 107 connected to the plunger 107 is stretched to switch on the valve seat 102 connected to one end of the resilient member 107 (S150).

When the valve seat 102 is switched on, the pipe C having the valve seat 102 disposed therein is opened to allow running water to be supplied thereto (S160), thereby increasing the temperature within the pipe C.

When a predetermined amount of running water is supplied to the pipe C, and the temperature within the pipe measured by the temperature sensor 103 is increased to a predetermined value or more, the contact 107 is disconnected from the first wire (S170) to block power supply to the coil assembly 106 via the first wire 108 (S180).

When power supply to the coil assembly 106 is blocked, the resilient member 104 placed between one end of the plunger 110 and the valve seat 102 is restored to an original state thereof to allow the valve seat 102 to rapidly close the pipe C (S190).

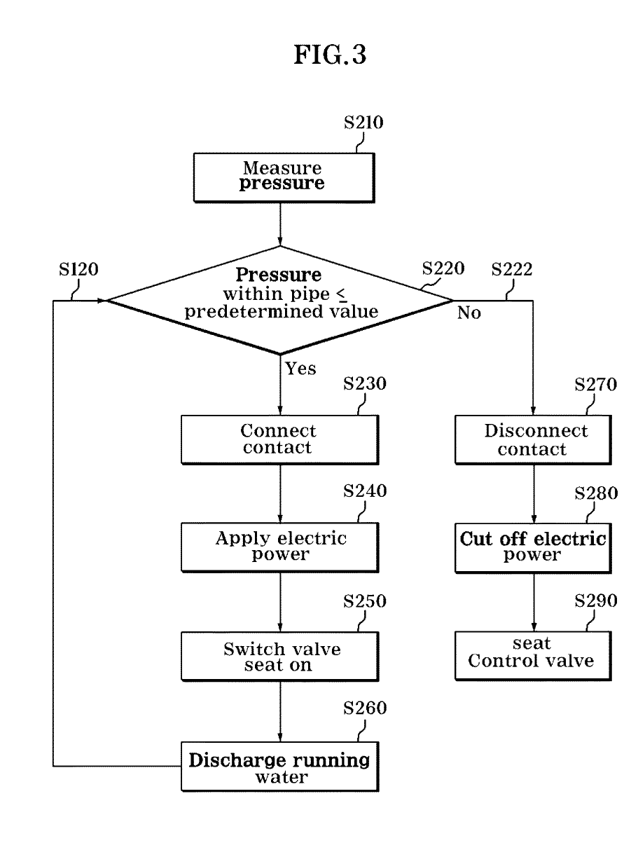

Next, the water-based system protection method using the water-based system protection apparatus 100 according to the embodiment of the present invention will be described with reference to FIG. 3, illustrating the case that a pipe is attached in the vicinity of a pump and shut-off pressure needs to be reduced.

Referring to FIG. 3, in the water-based system protection method using the water-based system protection apparatus 100 according to this embodiment, first, temperature within the pipe attached in the vicinity of a pump P is measured, and the pipe C is opened to reduce shut-off pressure based on the measured temperature, as shown in FIG. 2.

Here, a high-temperature temperature sensor 103 capable of detecting high temperature may be used for the pipe C in the vicinity of the pump P, which is a pressurized water supply system, whereas a low-temperature temperature sensor 103 may be used for an end of the pipe C, which is likely to freeze and burst in winter.

In addition to switching the valve seat 102 on/off to control shut-off pressure in response to variation in temperature within the pipe, in the water-based system protection method, hydraulic pressure within the pipe C is measured by the pressure sensor 105 (S210), and, when abnormal increase in pressure within the pipe or excessive pressure variation such as water-hammer is detected (S220), the contact 107 is connected to the second wire to provide electrical connection between the second wire 109 and the coil assembly 106 by operation of the pressure sensor 105, preferably a bellows-type pressure sensor, thereby allowing electric power to be applied to the coil assembly (S240).

When electric power is applied to the coil assembly 106, the plunger 110 is moved away from the valve seat 102 by translation motion due to a magnetic field generated in the coil assembly 106, and the resilient member 104 connected to the plunger 110 is stretched to sensitively switch on the valve seat 102 connected to one end of the resilient member 104 (S250) such that running water is discharged (S260) to reduce shut-off pressure, thereby protecting the water-based system.

Similarly, when running water is discharged and pressure within the pipe is decreased to a predetermined value or less (S222), the contact 107 is disconnected from between the second wire 109 and the coil assembly 106 (S270). As a result, when power supply to the coil assembly 106 is blocked (S280), the resilient member 104 is restored to an original state thereof to allow the valve seat 102 to close the pipe C (S290), as in FIG. 2.

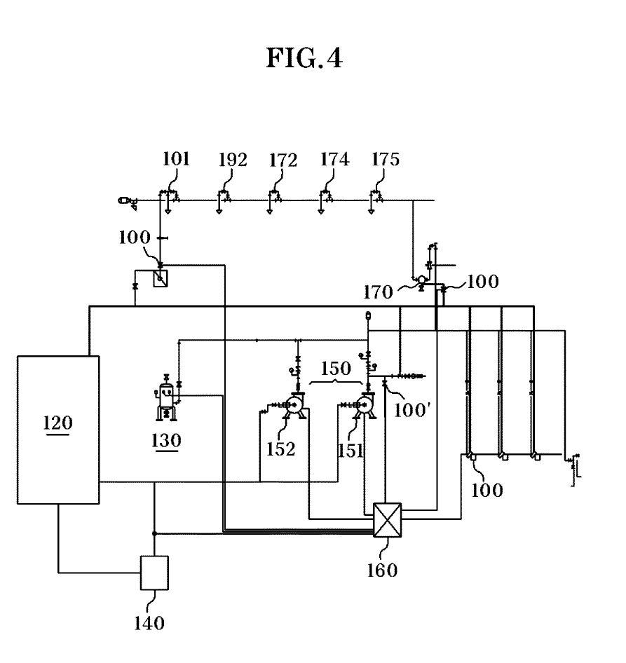

Next, a water-based system protection method using a water-based system protection apparatus according to one embodiment of the present invention will be described in more detail with reference to FIG. 4.

FIG. 4 is a diagram of a water-based system illustrating a water-based system protection method according to one embodiment of the present invention.

Referring to FIG. 4, the water-based system protection apparatus 100 according to the embodiment of the invention is disposed at each end of the pipe remote from a water tank 120, a hydraulic switch for activation 130 monitoring hydraulic pressure in the pipe and automatically activating a pump upon detecting decrease in hydraulic pressure due to operation such as valve opening, a hot water boiler 140, a pump 150, or a relief valve 160 connected thereto, for example, at each end of the pipe connected to sprinklers 171, 172, a foam extinguishing system 173, and water spray extinguishing systems 174, 175 in a high rise building via a water flow detection device 170, such that, when temperature within the pipe is less than or equal to a predetermined value or abnormal pressure variation is detected, the valve seat 102 of the water-based system protection apparatus 100 is driven to open the pipe C such that water is circulated to increase temperature or reduce pressure, thereby protecting the water-based system.

In addition, a water-based system protection apparatus 100′ according to one embodiment of the present invention may be disposed at a discharge side of the water tank 120, the hydraulic switch for activation 130, the hot water boiler 140, the pump 150, or the relief valve 160 connected thereto, such that heat and pressure generated during shut-off can be sensed by the temperature sensor 103 and the pressure sensor 105 to allow water to be circulated based on the measured values so as to reduce temperature and pressure, thereby protecting the water-based system.

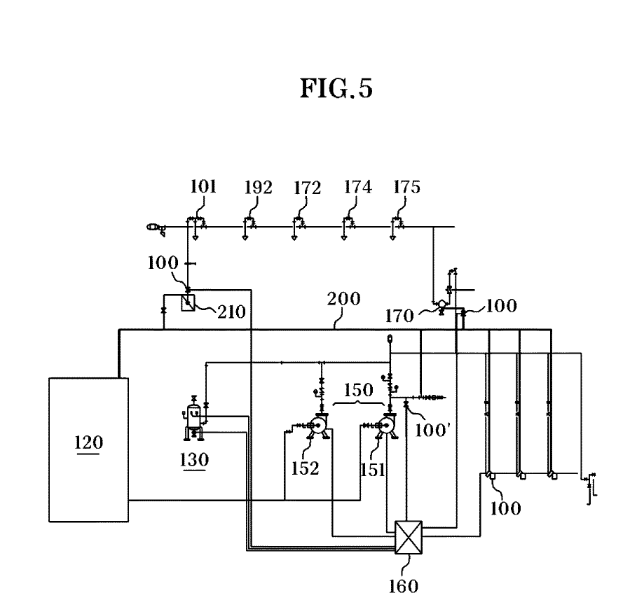

FIG. 5 is a diagram of a water-based system illustrating a water-based system protection method according to another embodiment of the present invention.

The water-based system protection method according to this embodiment is performed using a control panel 200 for water-based systems such that periodic inspection can be automatically conducted without a specialist or an expert.

The control panel 200 for water-based systems includes a timer 210, which is electrically connected to both the water-based system protection apparatus 100 disposed at each end of the pipe remote from the water tank 120, the hydraulic switch for activation 130, the hot water boiler 140, the pump 150, or the relief valve 160 connected thereto, and the water-based system protection apparatus 100′ disposed at the discharge side of the water tank 120, the hydraulic switch for activation 130, the hot water boiler 140, the pump 150, or the relief valve 160 connected thereto such that electric power is supplied to the water-based system protection apparatuses 100, 100′ at predetermined intervals for a predetermined period of time to open the pipe and circulate water so as to prevent the pipe from freezing and bursting while reducing shut-off pressure at the pump side to activate the hydraulic switch for activation to operate the pump and the like.

In addition, when power supply to the water-based system protection apparatuses 100, 100′ is blocked after a predetermined period of time, the pressure within the pipe is increased by the pump 150.

When the pressure within the pipe reaches a preset value of the hydraulic switch for activation 130, power supply to the pump 150 is blocked.

According to this embodiment of the invention, the pump 150 and the like are activated by a control panel 200 including a timer 210 and connected to the water-based system protection apparatuses 100, 100′, whereby periodic inspection can be conducted regardless of negligence of a worker.

The control panel 200 includes the timer 210 setting periodic inspection cycle and sends electric signals to the water-based system protection apparatus 100 at predetermined intervals for a predetermined period of time to operate the valve sheet 102. As a result, when water is discharged from the pipe and the pressure within the pipe is decreased to a pressure value preset in a pressure switch of the hydraulic switch for activation 130, the pump 150 is activated by the pressure switch, thereby conducting periodic inspection. After preset operation time of the pump or an internal combustion engine, the control panel stops sending signals to switch off the valve sheet 102 of the water-based system protection apparatus 100. As the water pressure within the pipe is maintained at a predetermined value, the pressure switch attached to the hydraulic switch for activation 130 stops sending electric signals to stop the pump 150.

Further, in order to prevent a distal end of the pipe from freezing and bursting, when the water-based system protection apparatus 100 detects decrease in temperature within the pipe to a predetermined value or less, the control panel 200 sends electric signals to allow the water-based system protection apparatus 100 to open the end of the pipe and cause the water-based system protection apparatuses 100′ placed at a discharge side of the boiler 140 to open the pipe such that fire-fighting water within the pipe is delivered to the end of the pipe. Here, among the pumps 150, which are pressurized water supply systems, a secondary pump (booster pump) capable of delivering water at a rate 60 L/min may be activated.

Since the secondary pump 152 is connected to the discharge side of the boiler 140, hot water from the boiler may be suctioned by the secondary pump 152 in operation of the secondary pump 152.

Here, a closed circuit, in which the hot fire-fighting water passes through the pump 150 and flows to the fire-extinguishing water tank 120 via the water-based system protection apparatus 100 at the pipe end, can be established, thereby preventing the pipe from freezing and bursting due to running water.

When the temperature within the pipe is increased to a predetermined value or more, the valve seat 102 of the water-based system protection apparatus 100 closes the pipe, whereby the water-based system may be maintained in a ready-to-use state.

Although the present invention has been described with reference to some embodiments in conjunction with the accompanying drawings, it should be understood that the foregoing embodiments are provided for illustration only and are not to be construed in any way as limiting the present invention, and that various modifications, changes, alterations, and equivalent embodiments can be made by those skilled in the art without departing from the spirit and scope of the invention.

1. A water-based system protection apparatus, comprising:
a valve seat disposed in a pipe to open/close the pipe;
a temperature sensor connected to one side of the pipe to measure temperature within the pipe;
a resilient member connected at one end thereof to the valve seat to restore the valve seat to an original state thereof in the absence of electric signals;
a pressure sensor connected to one side of the pipe to measure pressure within the pipe;
a coil assembly generating electromagnetic force for switching on the valve seat when the temperature sensor or the pressure sensor senses a predetermined temperature or pressure;
a contact driven to allow electric power to be applied to the coil assembly through a first wire or a second wire when the temperature sensor or the pressure sensor senses a predetermined temperature or pressure;
a plunger coupled to one end of the valve seat via the resilient member and electromagnetically moved by translational motion within the coil assembly to switch the valve seat on/off when the contact is driven to allow electric power to be applied to the coil assembly through the first wire or the second wire.

2. The water-based system protection apparatus according to claim 1, further comprising: a manual operation unit capable of manually driving the plunger to switch the valve seat on/off.

3. The water-based system protection apparatus according to claim 1, wherein the first wire or the second wire is connected to a control panel including a timer to receive electric signals at predetermined intervals for a predetermined period of time.

4. The water-based system protection apparatus according to claim 1, wherein the pressure sensor is a bellows-type pressure sensor, the temperature sensor and the pressure sensor are disposed vertically with respect to a longitudinal direction of the pipe, and a plunger is also disposed vertically with respect to a longitudinal direction of the pipe.

5. A water-based system protection method using a water-based system protection apparatus, the water-based system protection apparatus comprising: a valve seat disposed in a pipe to open/close the pipe; a temperature sensor connected to one side of the pipe to measure temperature within the pipe; a resilient member connected to the valve seat at one end thereof to restore the valve seat to an original state thereof in the absence of electric signals; a pressure sensor connected to one side of the pipe to measure pressure within the pipe; a coil assembly generating electromagnetic force for switching on the valve seat when the temperature sensor or the pressure sensor senses a predetermined temperature or pressure; a contact driven to allow electric power to be applied to the coil assembly through a first wire or a second wire when the temperature sensor or the pressure sensor senses a predetermined temperature or pressure; a plunger coupled to one end of the valve seat via the resilient member and being electromagnetically moved by translational motion within the coil assembly to switch the valve seat on/off when the contact is driven to allow electric power to be applied to the coil assembly through the first wire or the second wire, the method comprising:
measuring, by the temperature sensor, temperature within the pipe; and
when the measured temperature is less than or equal to a predetermined value, applying electric power to the coil assembly such that the valve seat is driven to open the pipe and running water is supplied to the pipe to increase the temperature within the pipe so as to prevent the pipe from freezing and bursting.

6. The water-based system protection method according to claim 5, further comprising: cutting off power supply to the coil assembly such that the valve seat closes the pipe when the measured temperature is higher than or equal to a predetermined value.

7. The water-based system protection method according to claim 5, further comprising: measuring, by the pressure sensor, pressure within the pipe; and applying electric power to the coil assembly such that the valve seat is driven to open the pipe and running water is discharged from the pipe to reduce shut-off pressure, upon detecting abnormal increase in pressure within the pipe or excessive pressure variation such as water-hammer.

8. The water-based system protection method according to claim 7, further comprising:
providing the water-based system protection apparatus to a discharge side of a water tank, a hydraulic switch for activation monitoring hydraulic pressure within the pipe and automatically activating a pump upon detecting decrease in hydraulic pressure due to operation such as valve opening, a hot water boiler, a pump or a relief valve connected thereto, or to each end of the pipe remote from these components and connected to a sprinkler, a foam extinguishing system, and a water spray extinguishing system in a high rise building; and connecting each water-based system protection apparatus to a control panel including a timer such that electric power is applied at predetermined intervals for a predetermined period of time to perform periodic inspection.

9. The water-based system protection method according to claim 8, wherein the control panel activates the hydraulic switch for activation to operate a secondary pump connected to the hydraulic switch for activation such that the secondary pump is connected to a discharge side of the boiler to circulate hot water from the boiler to an end of the pipe, upon receiving an electrical signal indicating that temperature of the end of the pipe is less than or equal to a predetermined value from the temperature sensor of the water-based system protection apparatus.

10. The water-based system protection method according to claim 9, wherein the boiler heats water using electricity, fossil fuel, solar heat, or industrial waste heat to produce hot water.
